(19) United States
(12) Patent Application Publication
(10) Pub. No.: US 2025/0232611 A1
(43) Pub. Date: Jul. 17, 2025

(54) AVATAR TRAINING IMAGES FOR TRAINING MACHINE LEARNING MODEL

(71) Applicant: Hewlett-Packard Development Company, L.P., Spring, TX (US)

(72) Inventors: Jishang Wei, Guilford, CT (US); Rafael Ballagas, Palo Alto, CA (US)

(73) Assignee: Hewlett-Packard Development Company, L.P., Spring, TX (US)

(21) Appl. No.: 18/702,785

(22) PCT Filed: Oct. 28, 2021
(86) PCT No.: PCT/US2021/056971

§ 371 Date: Apr. 18, 2024

(51) Int. Cl. G06V 40/16; G02B 27/01; G06T 13/40; G06V 10/70

(52) U.S. Cl. CPC G06V 40/174; G02B 27/0101; G02B 27/017; G06T 13/40; G06V 10/70; G06V 40/171; G02B 2027/0138

(57) ABSTRACT

Baseline blendshapes are identified from a captured facial image of a neutral facial expression of a user. For each of a number of facial expressions, blendshape weights are identified from a captured facial image of the facial expression of the user, and a blendshape model is generated by applying the blendshape weights to the baseline blendshapes. For each facial expression, an avatar is rendered from the blendshape model and avatar training images are simulated from the avatar in correspondence with facial images capturable by a head-mountable display (HMD). A machine learning model is trained based on the avatar training images for each facial expression.

### BACKGROUND

Extended reality (XR) technologies include virtual reality (VR), augmented reality (AR), and mixed reality (MR) technologies, and quite literally extend the reality that users experience. XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

### BRIEF DESCRIPTION OF THE DRAWINGS

FIGS. 1A and 1B are perspective and front view diagrams, respectively, of an example head-mountable display (HMD) that can be used in an extended reality (XR) environment.

FIG. 2 is a diagram of an example process for predicting blendshape weights for a facial expression of the wearer of an HMD from facial images of the wearer captured by the HMD.

FIGS. 3A, 3B, and 3C are diagrams of example facial images of the wearer of an HMD captured by the HMD, on which basis blendshape weights for the wearer's facial expression can be predicted.

FIG. 4 is a diagram of an example avatar that can be rendered to have the facial expression of the wearer of an HMD based on blendshape weights predicted for the wearer's facial expression.

FIG. 5 is a diagram of an example process for training a machine learning model that can be used to predict blendshape weights in FIG. 2, where the model is trained using training images of rendered avatars having facial expressions corresponding to specified blendshape weights identified from captured facial images of training users.

FIG. 6 is a diagram of example simulated HMD-captured training images of a rendered avatar, on which basis a machine learning model for predicting blendshape weights can be trained.

FIG. 7 is a flowchart of an example method.

FIG. 8 is a diagram of an example non-transitory computer- readable data storage medium.

FIG. 9 is a block diagram of an example HMD.

### DETAILED DESCRIPTION

As noted in the background, a head-mountable display (HMD) can be employed as an extended reality (XR) technology to extend the reality experienced by the HMD's wearer. An HMD can include one or multiple small display panels in front of the wearer's eyes, as well as various sensors to detect or sense the wearer and/or the wearer's environment. Images on the display panels convincingly immerse the wearer within an XR environment, be it a virtual reality (VR), augmented reality (AR), a mixed reality (MR), or another type of XR.

An HMD can include one or multiple cameras, which are image-capturing devices that capture still or motion images. For example, one camera of an HMD may be employed to capture images of the wearer's lower face, including the mouth. Two other cameras of the HMD may be each be employed to capture images of a respective eye of the HMD wearer and a portion of the wearer's face surrounding the eye.

In some XR applications, the wearer of an HMD can be represented within the XR environment by an avatar. An avatar is a graphical representation of the wearer or the wearer's persona, may be in three-dimensional (3D) form, and may have varying degrees of realism, from cartoonish to nearly lifelike. For example, if the HMD wearer is participating in an XR environment with other users wearing their own HMDs, the avatar representing the HMD wearer may be displayed on the HMDs of these other users.

The avatar can have a face corresponding to the face of the wearer of the HMD. To more realistically represent the HMD wearer, the avatar may have a facial expression in correspondence with the wearer's facial expression. The facial expression of the HMD wearer thus has to be determined before the avatar can be rendered to exhibit the same facial expression.

A facial expression can be defined by a set of blendshape weights of a facial action coding system (FACS). A FACS taxonomizes human facial movements by their appearance on the face, via values, or weights, for different blendshapes. Blendshapes may also be referred to as facial action units and/or descriptors, and the values or weights may also be referred to as intensities. Individual blendshapes can correspond to particular contractions or relaxations of one or more muscles, for instance. Any anatomically possible facial expression can thus be deconstructed into or coded as a set of blendshape weights representing the facial expression. It is noted that in some instances, facial expressions can be defined using blendshapes that are not specified by the FACS.

Facial avatars can be rendered to have a particular facial expression based on the blendshape weights of that facial expression. That is, specifying the blendshape weights for a particular facial expression allows for a facial avatar to be rendered that has the facial expression in question. This means that if the blendshape weights of the wearer of an HMD are able to be identified, a facial avatar exhibiting the same facial expression as the HMD wearer can be rendered and displayed.

One way to identify the blendshape weights of the wearer of an HMD is to employ a machine learning model that predicts the blendshape weights of the wearer's current facial expression from facial images of the wearer that have been captured by the HMD. However, training such a blendshape weights prediction model is difficult. Experts or other users may have to manually code thousands or more HMD-captured training images of different HMD wearers exhibiting different facial expressions with accurate blendshape weights.

Such a process is time consuming at best, and unlikely to yield accurate training data at worst. Since the accuracy of the machine learning model may depend on the quantity and diversity of the training data, acquiring large numbers of different HMD-captured training images of actual HMD wearers exhibiting different facial expressions can be paramount even if necessitating significant time and effort. Once the training images have been acquired, they then still have to be painstakingly manually coded with their constituent blendshape weights, which is to some degree a subjective process open to interpretation and thus affecting the quality or accuracy of the training data.

Techniques described herein provide for the prediction of blendshape weights for facial expressions of HMD wearers using a machine learning model that is trained on rendered avatar training images. That is, rather than training the blendshape weights prediction model using HMD-captured training images of actual HMD wearers that may have been laboriously acquired and painstakingly labeled with blendshape weights, the described techniques train the model using training images of rendered avatars. Such rendered avatar training images are more quickly generated, and are generated from specified blendshape weights that are identified in an automated manner. The training images do not have to be manually labeled with blendshape weights.

As noted, for instance, an avatar can be rendered to exhibit a particular facial expression from the blendshape weights for that facial expression. Simulated HMD-captured training images of such avatars can thus be generated and used to train the blendshape weights prediction model. Because the blendshape weights of each avatar training image are specified for a specific rendering of the avatar in question, no manual labeling or other coding of the weights is necessary.

The specified blendshape weights on which basis an avatar is rendered to exhibit a corresponding facial expression are particularly identified in the techniques described herein from a captured facial image of a training user when exhibiting that facial expression. The blendshape weights are identified in an automated manner, without having to be manually coded. Baseline blendshapes corresponding to a neutral facial expression are similarly identified in an automated manner from a captured facial image of the training user when exhibiting the neutral facial expression.

A blendshape model for the facial expression can then be generated by applying the identified blendshape weights for the facial expression to the identified baseline blendshapes for the neutral facial expression. An avatar exhibiting the facial expression is specifically rendered from the blendshape model. The simulated HMD-captured training images of the avatar can then be generated from the rendered avatar for training the blendshape weights prediction model.

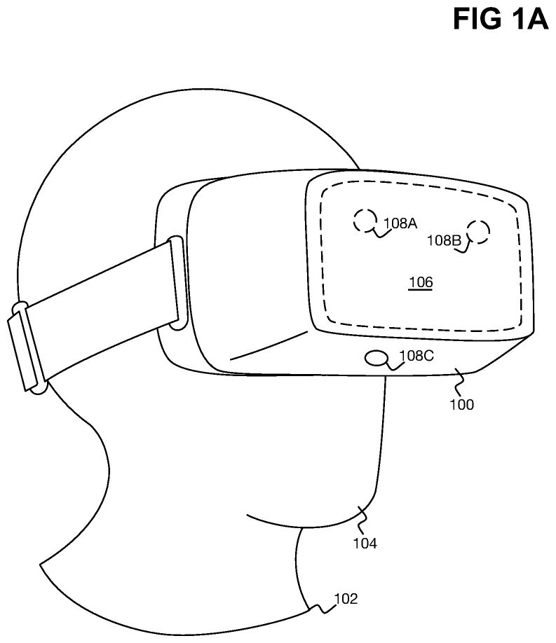

FIGS. 1A and 1B show perspective and front view diagrams of an example HMD 100 worn by a wearer 102 and positioned against the face 104 of the wearer 102 at one end of the HMD 100. Specifically, the HMD 100 can be positioned above the wearer 102's nose 151 and around his or her right and left eyes 152A and 152B, collectively referred to as the eyes 152 (per FIG. 1B). The HMD 100 can include a display panel 106 inside the other end of the HMD 100 that is positionable incident to the eyes 152 of the wearer 102. The display panel 106 may in actuality include a right display panel incident to and viewable by the wearer 102's right eye 152A, and a left display panel incident to and viewable by the wearer 102's left eye 152B. By suitably displaying images on the display panel 106, the HMD 100 can immerse the wearer 102 within an XR.

The HMD 100 can include eye camera 108A and 108B and/or a mouth camera 108C, which are collectively referred to as the cameras 108C. While just one mouth camera 108C is shown, there may be multiple mouth cameras 108C. Similarly, whereas just one eye camera 108A and one eye camera 108B are shown, there may be multiple eye cameras 108A and/or multiple eye cameras 108B. The cameras 108 capture images of different portions of the face 104 of the wearer 102 of the HMD 100, on which basis the blendshape weights for the facial expression of the wearer 102 can be predicted.

The eye cameras 108A and 108B are inside the HMD 100 and are directed towards respective eyes 152. The right eye camera 108A captures images of the facial portion including and around the wearer 102's right eye 152A, whereas the left eye camera 108B captures images of the facial portion including and around the wearer 102's left eye 152B. The mouth camera 108C is exposed at the outside of the HMD 100, and is directed towards the mouth 154 of the wearer 102 (per FIG. 1B) to capture images of a lower facial portion including and around the wearer 102's mouth 154.

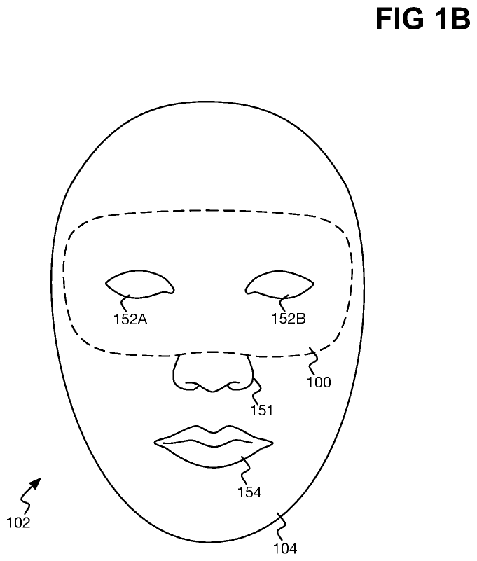

FIG. 2 shows an example process 200 for predicting blendshape weights for the facial expression of the wearer 102 of the HMD 100, which can then be retargeted onto an avatar corresponding to the wearer 102's face to render the avatar with a corresponding facial expression. The cameras 108 of the HMD 100 capture (204) a set of facial images 206 of the wearer 102 of the HMD 100 (i.e., a set of images 206 of the wearer 102's face 104), who is currently exhibiting a given facial expression 202. A trained machine learning model 208 is applied to the facial images 206 to predict blendshape weights 210 for the wearer 102's facial expression 202.

That is, the set of facial images 206 is input (214) into the trained machine learning model 208, with the model 208 then outputting (216) predicted blendshape weights 210 for the facial expression 202 of the wearer 102 based on the facial images 206. The trained machine learning model 208 may also output a predicted facial expression based on the facial images 206, which corresponds to the wearer 102's actual currently exhibited facial expression 202. Specific details regarding the machine learning model 208, particularly how training data can be generated for training the model 208, are provided later in the detailed description.

The predicted blendshape weights 210 for the facial expression 202 of the wearer 102 of the HMD 100 may then be retargeted (228) onto an avatar 230 corresponding to the face 104 of the wearer 102 to render the avatar 230 with this facial expression 202. The result of blendshape weight retargeting is thus an avatar 230 for the wearer 102. The avatar 230 has the same facial expression 202 as the wearer 102 insofar as the predicted blendshape weights 210 accurately reflect the wearer 102's facial expression 202. The avatar 230 is rendered from the predicted blendshape weights 210 in this respect, and thus has a facial expression corresponding to the blendshape weights 210.

The avatar 230 for the wearer 102 of the HMD 100 may then be displayed (232). For example, the avatar 230 may be displayed on the HMDs worn by other users who are participating in the same XR environment as the wearer 102. If the blendshape weights 210 are predicted by the HMD 100 or by a host device, such as a desktop or laptop computer, to which the HMD 100 is communicatively coupled, the HMD 100 or host device may thus transmit the rendered avatar 230 to the HMDs or host devices of the other users participating in the XR environment. In this respect, it is said that the HMD 100 or the host device indirectly displays the avatar 230, insofar as the avatar 230 is transmitted for display on other HMDs.

In another implementation, however, the HMD 100 may itself display the avatar 230. In this respect, it is said that the HMD 100 or the host device directly displays the avatar 230. The process 200 can be repeated with capture (204) of the next set of facial images 206 (234).

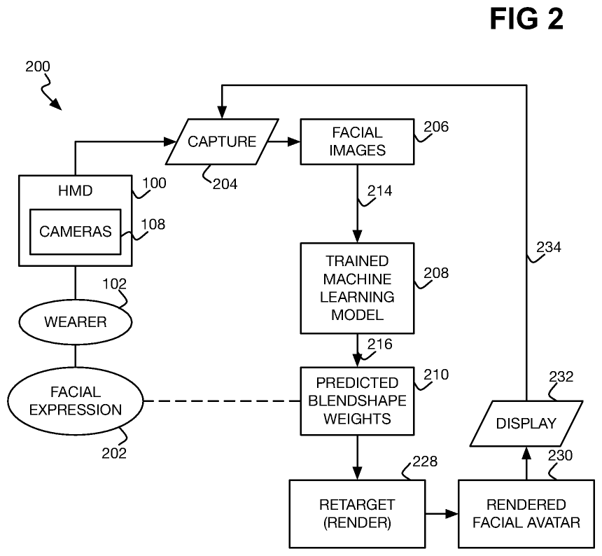

FIGS. 3A, 3B, and 3C show an example set of HMD-captured images 206A, 206B, and 206C, respectively, which are collectively referred to as and can constitute the images 206 to which the trained machine learning model 208 is applied to generate predicted blendshape weights 210. The image 206A is of a facial portion 302A including and surrounding the wearer 102's right eye 152A, whereas the image 206B is of a facial portion 302B including and surrounding the wearer 102's left eye 152B. The image 206C is of a lower facial portion 302C including and surrounding the wearer 102's mouth 154. FIGS. 3A, 3B, and 3C thus show examples of the types of images that can constitute the set of facial images 206 used to predict the blendshape weights 210.

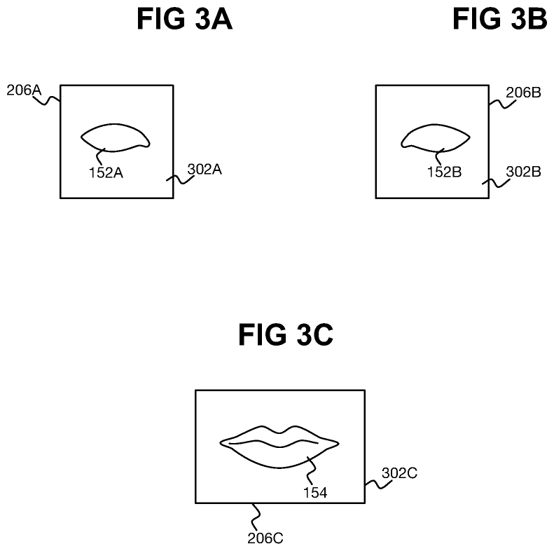

FIG. 4 shows an example image 400 of an avatar 230 that can be rendered when retargeting the predicted blendshape weights 210 onto the avatar 230. In the example, the avatar 230 is a two-dimensional (2D) avatar, but it can also be a 3D avatar. The avatar 230 is rendered from the predicted blendshape weights 210 for the wearer 102's facial expression 202. Therefore, to the extent that the predicted blendshape weights 210 accurately encode the facial expression 202 of the wearer 102, the avatar 230 has the same facial expression 202 as the wearer 102.

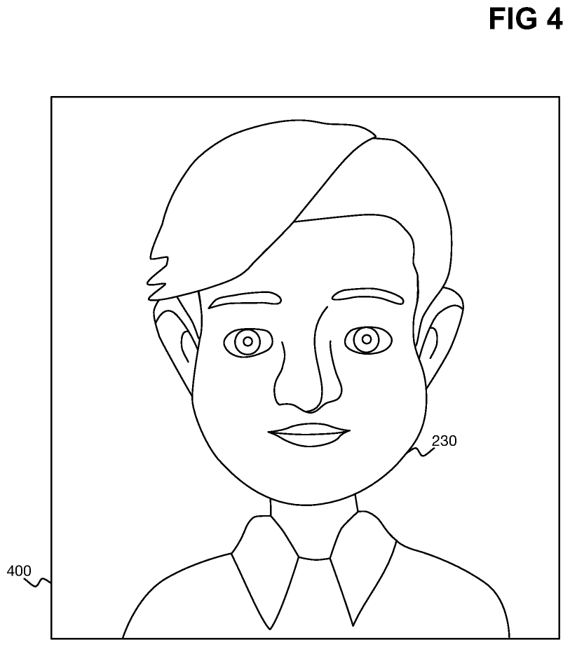

FIG. 5 shows an example process 500 for training the machine learning model 208 that can be used to predict blendshape weights 210 from HMD-captured facial images 206 of the wearer 102 of the HMD 100. For each of a number of training users, a facial image 502 of the training user is captured (501) when the training user is exhibiting a neutral facial expression 503. Facial images 504 of each training user are also captured (505) when the training user is exhibiting corresponding (non-neutral) facial expressions 507. Therefore, for each training user, one facial image 502 and multiple facial images 504 are captured.

A training user may first be requested to exhibit a neutral facial expression 503, after which the facial image 502 is captured. The facial image 502 may be automatically captured after the training user has been requested to exhibit the neutral facial expression 503, or the user may first have to provide input confirming that he or she is exhibiting the neutral facial expression 503. A training user may then be requested to exhibit a series of different particular facial expressions 507, such that a facial image 504 is captured as the user is requested to exhibit each particular facial expression 507. Different training users may be requested to exhibit the same or different particular facial expressions 507.

A training user may additionally or instead be requested to exhibit different facial expressions 507, without identifying any particular facial expression 507 for the user to exhibit. That is, the training user may him or herself decide which facial expressions 507 to exhibit in this case. Each training user is thus likely to exhibit different facial expressions 507.

For each training user, baseline blendshapes 506 corresponding to the neutral facial expression 503 are identified (508) from the facial image 502. Also for each training user, blendshape weights 510 corresponding to each facial expression 507 are identified (512) from the facial image 504 for that facial expression 507. The baseline blendshapes 506 for a training user define the basic facial structural of the training user, whereas each set of blendshape weights 510 define a corresponding facial expression 507 that was exhibited by the training user.

In one implementation, the sets of blendshape weights 510 corresponding to the facial expressions 507 are statistically analyzed, and any set of blendshape weights 510 that is an outlier (compared to the other sets of blendshape weights) is discarded (511). That is, in response to determining that a set of blendshape weights 510 is an outlier, the set is discarded. This means that in effect the corresponding facial expression 507 is discarded. The remainder of the process 500 is thus not performed for any facial expression 507 having an outlier set of blendshape weights 510.

How the baseline blendshapes 506 for the neutral facial expression 503 and the blendshape weights 508 for the facial expressions 507 are respectively identified from the facial image 502 and the facial images 504 can depend on how the images 502 and 504 are captured. For example, a red-green-blue-depth (RGB-D) camera may be employed, which provides a full-color image via red, green, and blue channels and depth (i.e., 3D) information via a depth channel. The presence of the depth information in addition to the RGB information permits identification of the baseline blendshapes 506 and the blendshape weights 508 from the facial image 502 and the facial images 504, respectively, either algorithmically or via a suitable model.

A second type of camera that can be employed to capture the facial image 502 and the facial images 504 for each training user is a multiple-view RGB camera that provides images corresponding to multiple views of a training user when exhibiting the neutral facial expression 503 or a facial expression 507. Depth information may then be able to be ascertained from these multiple views to permit identification of the baseline blendshapes 506 and the blendshape weights 508 as in the case when an RGB-D camera is employed.

A third type of camera that can be employed to capture the facial image 502 and the facial images 504 for each training user is a structured light camera that provides an 3D topographical image of a training user when exhibiting the neutral facial expression 503 or a facial expression 507. The 3D topographical information of such an image includes depth information, such that the blendshapes 506 and the blendshape weights 508 can be identified as when an RGB-D camera is employed.

The facial image 502 and the facial images 504 for each training user may instead be captured by a standard RGB camera that provides a single full-color image of a training user when exhibiting the neutral facial expression 503 or a facial expression 507. In this case, other sensors may also be employed to assist in identification of the baseline blendshapes 506 and the blendshape weights 508. For example, facial electromyographic sensors (fEMG) sensors may be employed to directly measure facial activity of a training user when exhibiting the neutral facial expression 503 or a facial expression 507, which along with the captured full-color image can be correlated to baseline blendshapes 506 or blendshape weights 508 algorithmically or via usage of a model.

The identification of the baseline blendshapes 506 from the captured facial image 502 of a training user when exhibiting a neutral facial expression 503 can be considered as the process of facial reconstruction. This is because the facial structure of the user's face, as represented or defined by the baseline blendshapes 506, is in effect mathematically reconstructed from the facial image 502. Similarly, the identification of the blendshape weights 510 from a captured facial image 504 of a training user when correspondingly exhibiting a facial expression 507 can be considered as the process of facial expression reconstruction. This is because the facial expression 507, as represented or defined by the blendshape weights 510, is in effect mathematically reconstructed from the facial image.

The number of sets of baseline blendshapes 506 is equal to the number of training users. The number of sets of blendshape weights 510 for each training user is equal to the number of different facial expression 507 that the training user in question exhibited. To generate even more sets of baseline blendshapes 506 and more sets of blendshape weights 510, random noise 512 may be added (514) to the baseline blendshapes 506 for each training user and added (518) to the blendshape weights 510 corresponding to each facial expression 507 exhibited by each training user, resulting in additional baseline blendshapes 516 and additional blendshape weights 510.

The same or different random noise 512 may be added to the baseline blendshapes 516 and the blendshape weights 520. Furthermore, (different) random noise 512 may be added multiple times to the baseline blendshapes 516 and the blendshape weights 520. Each time random noise 512 is added to the baseline blendshapes 516 and the blendshape weights 520, another set of additional baseline blendshapes 516 and another set of additional blendshape weights 520 are generated. A large number of blendshapes 516 and 506 can thus be generated from the captured facial image 502 of each training user, and a large number of blendshape weights 520 and 510 can thus be generated from the captured facial image 504 corresponding to each facial expression 507 of each training user.

Since the additional baseline blendshapes 516 are synthetically generated, and not directly identified from a captured facial image 502 of a training user, a given set of the additional baseline blendshapes 516 may reflect an unnatural neutral facial expression unlikely to be exhibitable by a user and thus an unnatural or physically impossible (or at least unlikely) facial structure of a user. Therefore, any additional baseline blendshapes 516 generated by introducing random noise 512 into the baseline blendshapes 506 that correspond to such an unnatural baseline facial expression are discarded (522). That is, in response to a set of additional baseline blendshapes 516 corresponding to an unnatural baseline facial expression, the set is discarded. For instance, natural neutral facial expression constraints may be applied to the sets of additional baseline blendshapes 516.

Similarly, since the additional blendshape weights 520 are synthetically generated, and not directly identified from a captured facial image 504 of a training user exhibiting a corresponding facial expression 507, a given set of the additional blendshape weights 520 may reflect an unnatural facial expression unlikely to be exhibitable by a user. Therefore, any additional blendshape weights 520 generated by introducing random noise 512 into the blendshape weights 510 that correspond to such an unnatural facial expression are discarded (524). That is, in response to a set of additional blendshape weights 520 correspond to an unnatural facial expression, the set is discarded. Natural facial expression constraints may be applied to the sets of additional blendshape weights 520 in this respect.

Blendshape models 526 are generated (528) from the baseline blendshapes 506, the additional baseline blendshapes 516 that remain after discarding, the blendshape weights 510, and the additional blendshape weights 520 that remain after discarded. A blendshape model 526 is the combination of a set of baseline blendshapes 506 or 516 and a set of blendshape weights 510 or 520. That is, a blendshape model 526 is the result of applying a set of blendshape weights 510 or 520 to a set of baseline blendshapes 506 or 516. Stated another way, a blendshape model 526 is a set of baseline blendshapes 506 or 516 as weighted by a set of blendshape weights 510 or 520. A blendshape model 526 is a parametric model that defines a facial structure (per the set of baseline blendshapes 506 or 516 in question) with a particular facial expression applied (per the set of blendshape weights 510 or 520 in question).

A blendshape model 526 can thus be generated for each combination of a set of baseline blendshapes 506 and a set of blendshape weights 510. A blendshape model 526 can be generated for each combination of a set of baseline blendshapes 506 and a set of additional blendshape weights 520. A blendshape model 526 can be generated for each combination of a set of additional baseline blendshapes 516 and a set of blendshape weights 510. A blendshape model 526 can be generated for each combination of a set of additional baseline blendshapes 516 and a set of additional blendshape weights 520.

In one implementation, blendshape models 526 are generated by

combining just the sets of blendshape weights 510 and 520 for a given training user with the sets of blendshapes 506 and 516 for the same user. That is, the blendshape weights 510 or 520 for a given training user are not combined with the sets of blendshapes 506 or 516 for any other training user. In another implementation, blendshape models 526 are generated by combining the sets of blendshape weights 510 and 520 with the sets of blendshapes 506 and 516 regardless of training user. For example, the blendshape weights 510 or 520 for a first training user may be combined with the sets of blendshapes 506 or 516 for another training user.

Because the blendshape models 526 parameterize facial structures with corresponding facial expressions 507, avatars 530 can be rendered (532) from (i.e., according to) the blendshape models 526. In one implementation, an avatar 530 is rendered from each blendshape model 526. However, different avatars 530 can be rendered from the same blendshape model 526 using different rendering parameters 534. For example, a base avatar 530 may be rendered from a blendshape model 526 according to baseline rendering parameters 534, and additional avatars 530 may be rendered from the same blendshape model 526 according to modified such rendering parameters 534. Different rendering parameters 534 may correspond to different amounts, sources, and directions of light, different skin color of the rendered avatars 530, and so on.

Each avatar 530 corresponds to a set of blendshape weights 510 or 520, and thus to a facial expression 507. More than one avatar 530 can correspond to the same set of blendshape weights 510 or 520, and thus to the same facial expression 507. This is because the same set of blendshape weights 510 or 520 may be combined with multiple sets of baseline blendshapes 506 and 516 to yield multiple blendshape models 526, and/or because multiple avatars 530 may be rendered from the same blendshape model 526 using different rendering parameters 534.

For each avatar 530, a set of HMD-captured avatar training images 536 can be simulated (538). The HMD-captured training images 536 for an avatar 530 simulate how an actual HMD, such as the HMD 100, would capture the face of the avatar 530 if the avatar 530 were a real person wearing the HMD 100. The simulated HMD-captured training images 536 can thus correspond to actual HMD-captured facial images 206 of an actual HMD wearer 102 in that the images 536 can be about the same size and resolution as and can include comparable or corresponding facial portions to those of the actual images 206.

Rendering of an avatar 530 based on specified blendshape weights 510 or 520 results in the avatar 530 exhibiting the facial expression 507 having or corresponding to these blendshape weights 510 or 520. Therefore, the resulting training images 536 of the avatar 530 are known to correspond to the specified blendshape weights 510 or 520, since the avatar 530 was rendered based on the blendshape weights 510 or 520. This means that manual labeling of the training images 536 with blendshape weights 510 or 520 is unnecessary, because the training images 536 have known blendshape weights 510 or 520 due to their avatars 530 having been rendered based on the blendshape weights 510 or 520.

The machine learning model 208 is then trained (540) based on the simulated HMD-captured avatar training images 536 and the blendshape weights 510 and 520 on which basis the avatars 530 from which the training images 536 were simulated were rendered. The model 208 is trained so that it accurately predicts the blendshape weights 510 and 520 from the simulated HMD-captured training images 536. The machine learning model 208 may also be trained based on the facial expressions 507 having the constituent blendshape weights 510 and 520 if labeled, provided, or otherwise known. The model 208 may be trained in this respect so that it also can accurately predict the facial expressions 507 from the simulated HMD-captured training images 536.

The machine learning model 208 may be any of a number of different types of models. For example, the machine learning model 208 may be a two-stage model. The first stage may be a backbone network, such as a convolutional neural network, which extracts image features from the simulated HMD-captured avatar training images 514. The second stage may include different head models to respectively predict the blendshape weights 510 and 520. The first and second stages of the machine learning model 208 can be trained in unison.

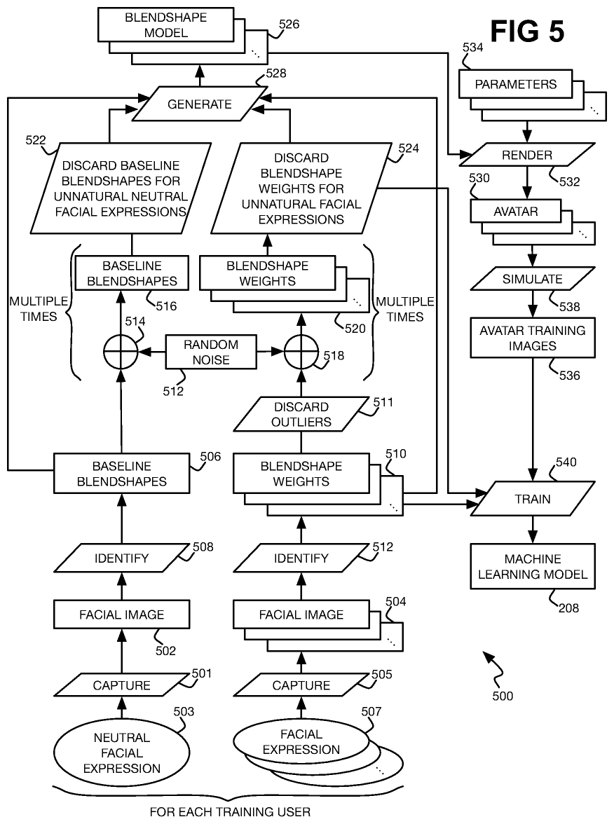

FIG. 6 shows an example rendered avatar 530. The rendered avatar 530 is a 3D avatar, and the more lifelike the avatar 530 is, the more accurate the resultantly trained machine learning model 208 will be. FIG. 6 also shows example HMD-captured avatar training images 536A, 536B, and 536C that are simulated from the rendered avatar 530 and that can be collectively referred to as the simulated HMD-captured training avatar images 536 on which basis the machine learning model 208 can be actually trained.

The simulated HMD-captured training image 536A is of a facial portion 606A surrounding and including the avatar 530′s left eye 608A, whereas the image 536B is of a facial portion 606B surrounding and including the avatar 530's right eye 608B. The training images 536A and 536B are thus left and right eye avatar training images that are simulated in correspondence with actual left and right eye images that can be captured by an HMD, such as the images 206A and 206B of FIGS. 3A and 3B, respectively. That is, the training images 536A and 536B may be of the same size and resolution and capture the same facial portions as actual HMD-captured left and right eye images.

The simulated HMD-captured training image 536C is of a lower facial portion 606C surrounding and including the avatar 530's mouth 610. The training image 536C is thus a mouth avatar training image that is simulated in correspondence with an actual mouth image captured by an HMD, such as the image 206C of FIG. 3C. Similarly, then, the training image 536C may be of the same size and resolution and capture the same facial portion as an actual HMD-captured mouth image. FIG. 6 thus shows avatar training images 536, as opposed to training images of an actual HMD wearer, for training the machine learning model 208.

In general, the avatar training images 536 match the perspective and image characteristics of the facial images of HMD wearers captured by the actual cameras of the HMDs on which basis the machine learning model 208 will be used to predict the wearers' facial expressions. That is, the avatar training images 536 are in effect captured by virtual cameras corresponding to the actual HMD cameras. The avatar training images 536 of FIG. 6 that have been described reflect just one particular placement of such virtual cameras. More generally, then, depending on the actual HMD cameras used to predict facial expressions of HMD wearers, the avatar training images 536 can vary in number and placement.

For example, the HMD mouth cameras may be stereo cameras so that more of the wearers' cheeks may be included within the correspondingly captured facial images, in which case the avatar training images 536 corresponding to such facial images would likewise capture more of the rendered avatars' cheeks. As another example, the HMD cameras may also include forehead cameras to capture facial images of the wearers' foreheads, in which case the avatar training images 536 would include corresponding images of the rendered avatars' foreheads. As a third example, there may be multiple eye cameras to capture the regions surrounding the wearers' eyes at different oblique angles, in which case the avatar training images 536 would also include corresponding such images.

As noted, using avatar training images 536 to train the machine learning model 208 can provide for faster and more accurate training. First, unlike training images of actual HMD wearers, large numbers of avatar training images 536 can be more easily acquired. Second, unlike training images of actual HMD wearers, such avatar training images 536 do not have to be manually labeled with blendshape weights 510 and 520, since the training images 536 are rendered from specified blendshape weights 510 and 520 identified and generated in an automated manner.

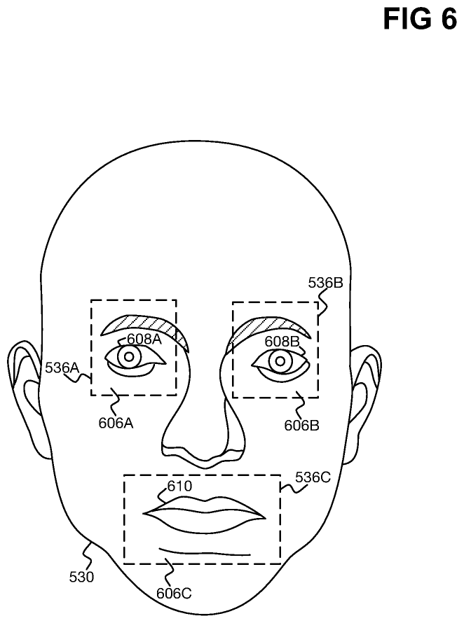

FIG. 7 shows an example method 700. The method 700 may be implemented as program code stored on a non-transitory computer-readable data storage medium and executed by a processor. The processor may be that of the HMD 100, in which case the HMD 100 performs the method 700, or it may be that of a host device to which the HMD 100 is communicatively connected, in which case the host device performs the method 700. The method 700 includes identifying baseline blendshapes 506 from a captured facial image 502 of a neutral facial expression 503 of a user (702).

The method 700 further includes, for each of a number of facial expressions 507, identifying blendshape weights 510 from a captured facial image 504 of the facial expression 507 of the user, and generating a blendshape model 526 by applying the blendshape weights 510 to the baseline blendshapes 506 (704). The method 700 includes for each facial expression 507, rendering an avatar 530 from the blendshape model 526 and simulating avatar training images 536 from the avatar in correspondence with facial images capturable by the HMD 100 (706). The method 700 includes training a machine learning model 208 based on the avatar training images 536 for each facial expression 507 (708).

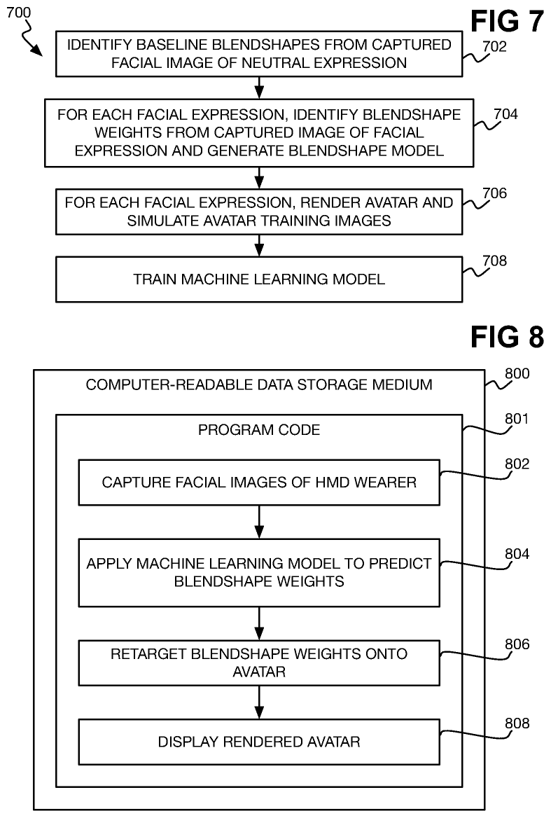

FIG. 8 shows an example non-transitory computer-readable data

storage medium 800 storing program code 801 executable by a processor to perform processing. As in FIG. 7, the processor may be that of the HMD 100, in which case the HMD 100 performs the processing, or it may be that of a host device to which the HMD 100 is communicatively connected, in which case the host device performs the processing. The processing includes capturing facial images 206 of a wearer 102 of an HMD 100 using corresponding cameras 108 of the HMD 100 (802). The processing includes applying a machine learning model 208 to the captured facial images 206 to predict blendshape weights 210 for a facial expression 202 of the wearer 102 of the HMD 100 exhibited within the captured facial images 206 (804).

The machine learning model is trained on simulated avatar training images 536 of training avatars 530 rendered from blendshape models 526 corresponding to facial expressions 507 and generated by applying blendshape weights 510 identified from captured training facial images 504 of the facial expressions 507 to baseline blendshapes 506 identified from a captured training facial image 502 of a neutral facial expression 503. The processing further includes retargeting the predicted blendshape weights 210 for the facial expression 202 of the wearer 102 of the HMD 100 onto an avatar 230 corresponding to the wearer 102 to render the avatar 230 with the facial expression 202 of the wearer 102 (806). The processing includes directly or indirectly displaying the rendered avatar 230 corresponding to the wearer 102 (808).

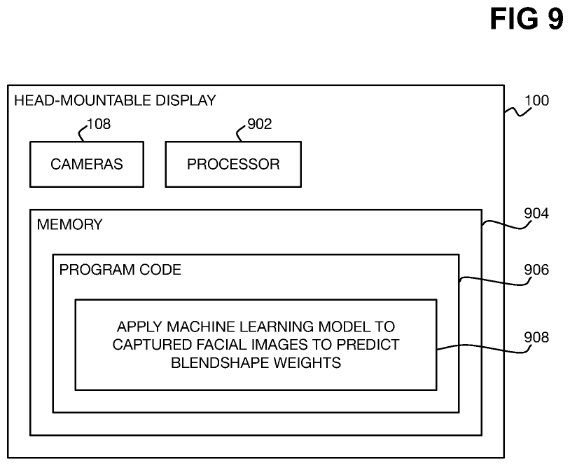

FIG. 9 shows the example HMD 100. The HMD 100 includes one or multiple cameras 108 to capture facial images 206 of a wearer 102 of the HMD 100. The HMD 100 includes a processor 902 and a memory 904, which can be a non-transitory computer-readable data storage medium, storing program code 906. The processor 902 and the memory 904 may be integrated within an application-specific integrated circuit (ASIC) in the case in which the processor 902 is a special-purpose processor. The processor 902 may instead be a general-purpose processor, such as a central processing unit (CPU), in which case the memory 904 may be a separate semiconductor or other type of volatile or non-volatile memory 904. The HMD 100 may include other components as well, such as the display panel 106, various sensors, and so on.

The program code 906 is executable by the processor 902 to perform processing. The processing can include a machine learning model 208 to the captured facial images 206 to predict blendshape weights 210 for a facial expression 202 of the wearer 102 of the HMD 100 exhibited within the captured facial images 206 (908). The machine learning model is trained on simulated avatar training images 536 of training avatars 530 rendered from blendshape models 526 corresponding to facial expressions 507 and generated by applying blendshape weights 510 identified from captured training facial images 504 of the facial expressions 507 to baseline blendshapes 506 identified from a captured training facial image 502 of a neutral facial expression 503.

Techniques have been described for generating avatar training images for training a machine learning model to predict blendshape weights corresponding to a facial expression of a wearer of an HMD, from facial images of the wearer as captured by the HMD. The avatar training images are simulated from avatars that are rendered according to blendshape models generated by combining blendshape weights and baseline blendshapes. The blendshape weights and the baseline blendshapes are identified in an identified manner. Therefore, large sets of avatar training images can be more quickly generated than if the blendshape weights had to be manually coded.

We claim:

1. A method comprising:
identifying baseline blendshapes from a captured facial image of a neutral facial expression of a user;
for each of a plurality of facial expressions, identifying blendshape weights from a captured facial image of the facial expression of the user, and generating a blendshape model by applying the blendshape weights to the baseline blendshapes;
for each facial expression, rendering an avatar from the blendshape model and simulating avatar training images from the avatar in correspondence with facial images capturable by a head-mountable display (HMD); and
training a machine learning model based on the avatar training images for each facial expression.

2. The method of claim 1, further comprising:
applying the machine learning model to the facial images captured by the HMD of a wearer exhibiting a facial expression to predict the blendshape weights for the facial expression of the wearer.

3. The method of claim 2, further comprising:
retargeting the predicted blendshape weights for the facial expression of the wearer of the HMD onto an avatar corresponding to the wearer to render the avatar with the facial expression of the wearer; and
displaying the rendered avatar corresponding to the wearer.

4. The method of claim 1, further comprising:
adding random noise to the baseline blendshapes to generate additional baseline blendshapes; and
for each facial expression, generating an additional blendshape model by applying the blendshape weights to the additional baseline blendshapes, rendering an additional avatar from the additional blendshape model, and simulating additional avatar training images from the additional avatar in correspondence with the facial images capturable by the HMD,
wherein the machine learning model is further trained based on the additional avatar training images for each facial expression.

5. The method of claim 4, further comprising:
in response to the additional blendshapes corresponding to an unnatural neutral facial expression unlikely to be exhibitable by a wearer of the HMD, discarding the additional blendshapes, such that the additional blendshape model is not generated, the additional avatar is not generated, and the additional avatar training images are not simulated.

6. The method of claim 1, further comprising, for each facial expression:
adding random noise to the blendshape weights to generate additional blendshape weights, generating an additional blendshape model by applying the additional blendshape weights to the baseline blendshapes, rendering an additional avatar from the additional blendshape model, and simulating additional avatar training images from the additional avatar in correspondence with the facial images capturable by the HMD,
wherein the machine learning model is further trained based on the additional avatar training images for each facial expression.

7. The method of claim 6, further comprising, for each facial expression:
in response to the additional blendshape weights corresponding to an unnatural facial expression unlikely to be exhibitable by a wearer of the HMD, discarding the additional blendshape weights, such that the additional blendshape model is not generated, the additional avatar is not generated, and the additional avatar training images are not simulated.

8. The method of claim 1, further comprising:
adding random noise to the baseline blendshapes to generate additional baseline blendshapes;
for each facial expression, adding random noise to the blendshape weights to generate additional blendshape weights, generating an additional blendshape model by applying the additional blendshape weights to the additional baseline blendshapes, rendering an additional avatar from the additional blendshape model, and simulating additional avatar training images from the additional avatar in correspondence with the facial images capturable by the HMD,
wherein the machine learning model is further trained based on the additional avatar training images for each facial expression.

9. The method of claim 1, wherein the avatar for each facial expression is rendering using first avatar rendering parameters, the method further comprising, for each facial expression:
rendering an additional avatar from the blendshape model using second avatar rendering parameters and simulating additional avatar training images from the additional avatar in correspondence with the facial images capturable by the HMD,
wherein the machine learning model is further trained based on the additional avatar training images for each facial expression.

10. The method of claim 1, further comprising:
discarding each facial expression for which the blendshape weights are outliers compared to the blendshape weights for other of the facial expressions, such that the blendshape model is not generated, the avatar is not rendered, and the avatar training images are not simulated.

11. A non-transitory computer-readable data storage medium storing program code executable by a processor to perform processing comprising:
capturing facial images of a wearer of a head-mountable display (HMD) using corresponding cameras of the HMD;
applying a machine learning model to the captured facial images to predict blendshape weights for a facial expression of the wearer of the HMD exhibited within the captured facial images;
retargeting the predicted blendshape weights for the facial expression of the wearer of the HMD onto an avatar corresponding to the wearer to render the avatar with the facial expression of the wearer; and
directly or indirectly displaying the rendered avatar corresponding to the wearer,
wherein the machine learning model is trained on simulated avatar training images of training avatars rendered from blendshape models corresponding to facial expressions and generated by applying blendshape weights identified from captured training facial images of the facial expressions to baseline blendshapes identified from a captured training facial image of a neutral facial expression.

12. The non-transitory computer-readable data storage medium of claim 11, wherein the captured facial images of the wearer comprise captured left and right eye images of facial portions of the wearer respectively including left and right eyes of the wearer, and a captured mouth image of a lower facial portion of the wearer including a mouth of the wearer.

13. The non-transitory computer-readable data storage medium of claim 12, wherein for each training avatar, the simulated avatar training images comprise simulated avatar left and right eye images in correspondence with the captured left and right eye images of the facial portions of the wearer respectively including the left and right eyes of the wearer, and a simulated avatar mouth image in correspondence with the captured mouth image of the lower portion of the wearer including the mouth of the wearer.

14. A head-mountable display (HMD) comprising:
cameras to capture facial images of a wearer of the HMD;
a processor; and
a memory storing program code executable by the processor to apply a machine learning model to the captured facial images to predict blendshape weights for a facial expression of the wearer of the HMD exhibited within the captured facial images,
wherein the machine learning model is trained on simulated avatar training images of training avatars rendered from blendshape models corresponding to facial expressions and generated by applying blendshape weights identified from captured training facial images of the facial expressions to baseline blendshapes identified from a captured training facial image of a neutral facial expression.

15. The HMD of claim 14, wherein the program code is executable by the processor to further:
retarget the predicted blendshape weights for the facial expression of the wearer of the HMD onto an avatar corresponding to the wearer to render the avatar with the facial expression of the wearer; and
display the rendered avatar corresponding to the wearer on a display of the HMD, or transmit the rendered avatar corresponding to the wearer to a computing device to indirectly display the rendered avatar on a display of the computing device.
